(19) United States
(12) Patent Application Publication
(10) Pub. No.: US 2025/0356520 A1
(43) Pub. Date: Nov. 20, 2025

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Naoki NISHIZAWA, Kawasaki (JP); Tomoki WATANABE, Inagi (JP); Atsushi KAWASAKI, Yokohama (JP)

(73) Assignee: KABUSHIKI KAISHA TOSHIBA, Tokyo (JP)

(21) Appl. No.: 19/044,683

(22) Filed: Feb. 4, 2025

(30) Foreign Application Priority Data
May 20, 2024 (JP) 2024-081472

(51) Int. Cl. G06T 7/70; G06T 7/20; G06T 7/62

(52) U.S. Cl. CPC G06T 7/70; G06T 7/20; G06T 7/62; G06T 2207/10028

(57) ABSTRACT

An information processing apparatus includes one or more hardware processors configured to function as an acquisition unit, a detection unit, an estimation unit, and a generation unit. The acquisition unit acquires a first image and a second image. The detection unit detects an object captured in the first image by using at least the first image. The estimation unit estimates a relative position of the object based on an imaging position of a target image by using the target image that is at least one of the first image and the second image. The generation unit generates specifying information in which object identification information for identifying the object, facility information based on the relative position, and image identification information for identifying the target image are associated with each other.

### CROSS-REFERENCE TO RELATED APPLICATIONS

This application is based upon and claims the benefit of priority from Japanese Patent Application No. 2024-081472, filed on May 20, 2024; the entire contents of which are incorporated herein by reference.

### FIELD

Embodiments described herein relate generally to an information processing apparatus, an information processing method, and a computer program product.

### BACKGROUND

For the purpose of detecting anomalies of road facilities, a system for updating and managing a database relating to road facilities using a video captured by an in-vehicle camera has been proposed. For example, such a system includes a database including a plurality of reference images for each road facility, and selects and outputs a reference image having the closest imaging condition to the latest image obtained by imaging the road facility from the database. By using the imaging position as the imaging condition, it is possible to compare the reference image captured at the same position with the latest image and to easily determine the time-series changes in the road facility. The reason for using the images having the same (or close) imaging position is that, how the facility looks (appearance) varies unless the imaging position is close, and it is difficult to distinguish whether the facility itself makes time-series changes or whether the facility simply looks differently.

### BRIEF DESCRIPTION OF THE DRAWINGS

FIG. 1 is a block diagram of an information processing system according to an embodiment;

FIG. 2 is a flowchart of generation processing according to the embodiment;

FIG. 3 is a flowchart of display processing according to the embodiment;

FIG. 4 is a view illustrating an example of a display screen displayed on a display unit;

FIG. 5 is a view illustrating an example of the display screen displayed on the display unit; and

FIG. 6 is a hardware configuration diagram of the information processing apparatus according to the embodiment.

### DETAILED DESCRIPTION

An information processing apparatus according to an embodiment includes one or more hardware processors configured to function as an acquisition unit, a detection unit, an estimation unit, and a generation unit. The acquisition unit acquires a first image and a second image. The detection unit detects an object captured in the first image by using at least the first image. The estimation unit estimates a relative position of the object based on an imaging position of a target image by using the target image that is at least one of the first image and the second image. The generation unit generates specifying information in which object identification information for identifying the object, facility information based on the relative position, and image identification information for identifying the target image are associated with each other.

Hereinafter, a preferred embodiment of an information processing apparatus according to the present disclosure will be described in detail with reference to the accompanying drawings.

Hereinafter, an example in which an object detected from an image is a facility (road facility) on a road on which a moving vehicle such as a travelling vehicle will be mainly described. The road facility includes, for example, a sign, a signboard, a traffic light, and the like. The object detected from the image is not limited to the road facility, and may be any other objects.

The image is captured by, for example, an in-vehicle camera (an example of an imaging device) mounted on a moving vehicle traveling on road, but may be captured by any other imaging device. For example, the imaging device may be an imaging device mounted on a railway vehicle traveling on a railway track or an imaging device mounted on a moving vehicle such as an automated guided vehicle (AGV) traveling indoors. In these cases, the facility may include structures or the like around the traveling route of the railway vehicle or the moving vehicle.

As a moving vehicle on which an imaging device such as an in-vehicle camera is mounted moves, image data (video) including a plurality of images at consecutive times is obtained by the imaging device. In a case where an anomaly of the road facility is detected, for example, images including the same road facility are extracted from a plurality of videos captured at different times and displayed so as to be able to be compared.

As described above, as a technology for detecting an anomaly of a road facility, a system is proposed that outputs a plurality of images captured at the same position so as to enable comparisons (Comparative Example 1). For this technology, for example, the imaging position of an image is acquired using a global positioning system (GPS).

As a method of selecting a reference image, a method of using similarity between images is also conceivable (Comparative Example 2). An image having a high degree of similarity with a captured image is expected to have a close imaging position. Furthermore, as a method of selecting the reference image, a method of using the size of the subject (subject size) in the image is also conceivable (Comparative Example 3). The images having the same subject size are expected to have the same distance to the subject and to have a close imaging position. It is possible to easily determine the time-series change in the road facility by outputting the reference image having a close imaging position and the latest image so that the reference image and the latest image can be compared with each other.

In Comparative Example 1, the reference image is selected based on the imaging position acquired by the GPS. Therefore, in a case where an inexpensive GPS with low accuracy is used, there is a possibility that it is difficult to select a reference image having the same imaging position due to a positioning error of the GPS. In addition, in an environment such as inside a tunnel and indoors where GPS information cannot be received, an imaging position cannot be acquired, and the technology of Comparative Example 1 cannot be used.

In addition, in Comparative Example 2, in a case where the scenery around the road varies due to an increase or decrease in the number of buildings or the like, there is a possibility that the images are no longer similar, and thus, it is not always possible to select reference images having the same imaging position.

In addition, in Comparative Example 3, in a case where the subject is shielded by trees or the like, there is a possibility that the subject size may vary, and thus, reference images having the same imaging position are not always selectable.

An information processing apparatus according to an embodiment estimates a relative position of an object (facility) with an imaging position as a reference with respect to each of images including facility (hereinafter, a facility image) in a video captured by a moving imaging device. The information processing apparatus generates and outputs information (hereinafter, specifying information) in which information based on the estimated relative position (facility information) is associated with identification information of the facility image. It is expected that the images in which the relative positions of the facilities are the same have the same imaging positions. Therefore, it is possible to extract and compare facility images captured at the same position with respect to videos captured at different dates and times.

In the present embodiment, the relative position of the facility can be estimated from the image. Therefore, it is possible to avoid a positioning error and a problem of environmental dependency that may occur in the technology using the GPS (Comparative Example 1). In addition, as long as there is an image from which the relative position of the facility can be estimated, it is possible to extract an image captured at the same position regardless of a change in the scenery around the road, a shadowing object, or the like.

In addition, in the present embodiment, a plurality of images having the same relative position extracted from each of a plurality of videos is displayed in an easily recognizable format. This makes it possible to more easily compare a plurality of images obtained by capturing an object such as a road facility.

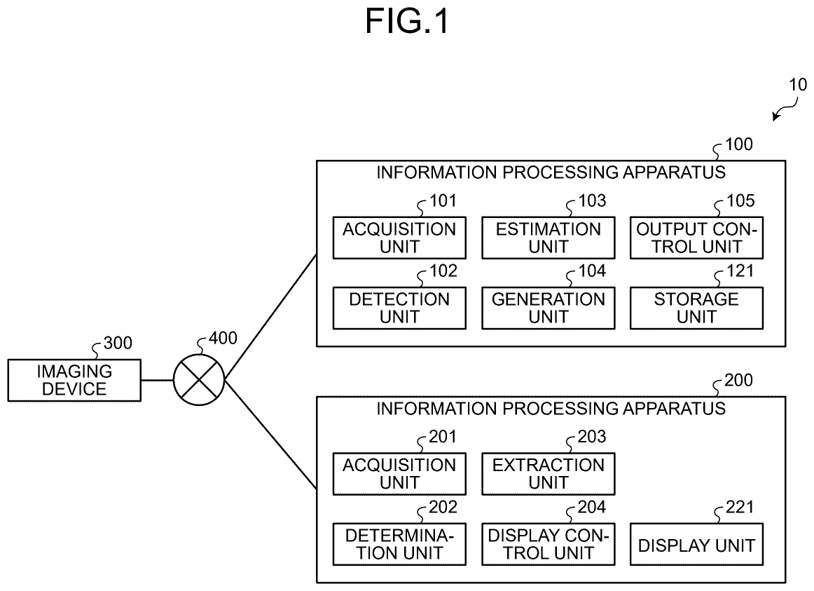

FIG. 1 is a block diagram illustrating an example of a configuration of an information processing system 10 according to an embodiment. As illustrated in FIG. 1, the information processing system 10 has a configuration in which information processing apparatuses 100 and 200 and an imaging device 300 are connected via a network 400.

The network 400 may be a network of any form, and can be configured by, for example, the Internet. The network 400 may be any of a wired network, a wireless network, and a wired and wireless network.

The imaging device 300 is an imaging device such as an in-vehicle camera mounted on a moving vehicle. The imaging device 300 captures an image while moving with the movement of the moving vehicle. The imaging device 300 is implemented by, for example, a drive recorder, a video camera, a stereo camera, an infrared sensor, and the like. Although one imaging device 300 is illustrated in FIG. 1, a plurality of imaging devices 300 may be provided as described in a modification.

The information processing apparatus 100 corresponds to an apparatus that generates and outputs specifying information for specifying an image to be displayed for the purpose of, for example, detecting an anomaly from a video. The information processing apparatus 200 corresponds to an apparatus that extracts an image specified by the specifying information from a video and displays the image.

First, functions of the information processing apparatus 100 will be described. The information processing apparatus 100 includes an acquisition unit 101, a detection unit 102, an estimation unit 103, a generation unit 104, an output control unit 105, and a storage unit 121.

The acquisition unit 101 acquires various types of information used in the information processing apparatus 100. For example, the acquisition unit 101 acquires a video captured by the imaging device 300. The video includes a plurality of images (time-series images) captured at different times. Each image included in the video is identified by identification information (hereinafter, image identification information) such as a time and a frame number.

The acquisition unit 101 may acquire an image associated with additional information such as GPS information and vehicle speed information. The GPS information is, for example, information that is acquired by GPS and indicates a position where each image included in the video is captured. The vehicle speed information is, for example, the speed of the moving vehicle on which the imaging device 300 is mounted when each image included in the video is captured.

The video corresponds to information including the image IA (first image) and the image IB (second image). Each of the image IA and the image IB is, for example, an image captured at time t1 and time t2 among the images included in the video. It can be interpreted that the image IB corresponds to an image captured at an imaging position different from the image IA by the imaging device 300 that captures the image IA.

A method of acquiring information by the acquisition unit 101 may be any method, and for example, a method of receiving information from an external apparatus via the network 400, a method of reading information from a storage medium, or the like can be applied.

The detection unit 102 detects an object (facility) captured in the image by using the image acquired by the acquisition unit 101. For example, the detection unit 102 detects an object captured in the image IA using at least the image IA.

The object detection method by the detection unit 102 may be any method, and for example, a method using a machine learning model trained in advance using a facility image for training (image recognition processing) can be applied. The machine learning model is trained, for example, to input an image at a certain time and output a label indicative of a type of a facility, information indicative of an area including the facility in the image (such as a bounding box), and a score indicative of reliability of detection.

In addition to the output (label, bounding box, score) of the machine learning model, the detection unit 102 outputs, as a detection result, data in which image identification information of an image (facility image) in which a facility is detected, an imaging position obtained by GPS (for example, GPS information) or the like, and the like are associated with each other.

The detection unit 102 may detect two or more facilities from a plurality of images included in a video at different times or one image included in the video. The detection unit 102 assigns unique identification information (hereinafter, the object identification information) to the detected one or more facilities. Hereinafter, the object identification information may be referred to as facility ID.

The detection unit 102 may perform tracking processing on the detected facility and assign the same facility ID to the same facility detected from a plurality of images. The tracking processing can be implemented, for example, by matching detected bounding boxes of facilities detected in two or more images continuous in time series.

The estimation unit 103 estimates a relative position of an object (facility) based on an imaging position. The relative position may be represented in any form, and is represented by, for example, a three-dimensional vector. The three-dimensional vector is a vector representing a position of a facility with an imaging position as a reference (base point).

For example, the estimation unit 103 estimates the relative position of the object based on the imaging position of the target image by using the target image that is at least one of the image IA and the image IB. In the present embodiment, the estimation unit 103 estimates the relative position from the time-series images using Structure from Motion (SfM). In this case, the target image is both the image IA and the image IB. In the SEM, the relative position is estimated using one or more sets (hereinafter, an image pair) including the image IA and the image IB. That is, the estimation unit 103 estimates the relative position using one or more image pairs.

A method of estimating the relative position by the SfM will be further described. In SfM, the camera motion and the three-dimensional relative position from the imaging position of the imaging device 300 to the subject are estimated from the correspondence relationship of points between a plurality of images (image IA, image IB) including the same subject imaged by the moving imaging device 300. Therefore, the estimation unit 103 extracts a plurality of images adjacent in time series in which the same facility is detected from the video, and performs SfM using the plurality of extracted images, thereby estimating the relative position of the facility.

In SfM, the relative position from the imaging position is obtained for at least some pixels included in the image. The estimation unit 103 estimates one relative position for each facility by using the obtained relative position for each pixel. The method of estimating the relative position for each facility may be any method, and for example, the following method can be applied.

A representative pixel is selected from a plurality of pixels corresponding to the facility, and the relative position of the representative pixel is estimated as the relative position of the facility. The representative pixel is, for example, a pixel closest to the center or the center of gravity of a region including the facility (for example, the detected bounding box) among a plurality of pixels corresponding to the facility.

A statistical value of relative positions of a plurality of pixels corresponding to the facility is estimated as the relative position of the facility. The statistical value is, for example, an average value and a median value.

Note that the relative position obtained by SEM with respect to the image captured by one imaging device 300 (corresponding to a monocular camera) is not based on absolute scale. Therefore, the estimation unit 103 corrects the scale of relative position using known information capable of calculating the scale of the distance. The known information is, for example, at least a part of the following information. Height of the imaging device 300 with reference to traveling surface (road surface or the like) of the moving vehicle on which the imaging device 300 is mounted.

### a Plurality of Imaging Positions (a Plurality of Imaging Positions at Different Times, Etc.)

Speed at which the Imaging Device 300 (the Moving Vehicle on which the Imaging Device 300 is Mounted) Moves
Size of the Subject with Known Actual Size

The generation unit 104 generates specifying information for specifying an image to be extracted from the video. The specifying information is, for example, information in which facility ID (object identification information) of a facility (object), facility information based on the estimated relative position, and image identification information of a facility image are associated with each other.

The facility information based on the relative position may be the relative position itself (three-dimensional vector) or may be information in another format obtained from the relative position. For example, the facility information may be the following information.

Distance: represents a distance from an imaging position to a position of the facility. The distance is calculated by, for example, a size (absolute value) of a three-dimensional vector representing a relative position.

Angle: represents an angle in a direction from an imaging position to a position of the facility with respect to a reference direction. The reference direction is, for example, a direction in which a subject at the center of an image is imaged from an imaging position. The angle may be a rotation angle with respect to a predetermined axis. For example, the angle may be a rotation angle (yaw angle) with respect to the vertical axis.

The facility information can be used to specify, from each of the plurality of videos, facility images obtained by imaging the same facility and having close imaging position values. The fact that the values of the imaging positions are close means that, for example, the imaging position is within a predetermined range.

For example, in a case where the relative position itself (three-dimensional vector) is used as the facility information, facility images having close relative position values can be specified as facility images having close imaging position values.

It is valid to use the distance as the facility information in a case where the imaging device 300 is installed so as to image the front or rear of the moving vehicle. Between a plurality of images captured by such an imaging device 300 and including the same facility, variance of distances is large, but variance of angles is small. That is, a plurality of facility images having close distance values can be interpreted as images having close relative position (imaging position) values.

It is valid to use the angle as the facility information in a case where the imaging device 300 is installed to image the side of the moving vehicle. Between a plurality of images captured by such an imaging device 300 and including the same facility, variance of angles is large, but variance of distances is small. That is, a plurality of facility images having close angle values can be interpreted as images having close relative position (imaging position) values.

The facility information can also be used as information for designating an imaging position of an image to be specified. For example, distances and angles are represented by scalar values. Therefore, a slider for specifying a scalar value, an input field for inputting a scalar value, or the like can be used as a user interface for specifying an imaging position.

The output control unit 105 controls output of various types of information used in the information processing apparatus 100. For example, the output control unit 105 outputs the generated specifying information. The information output method may be any method, and for example, a method of transmitting information to an external apparatus (such as the information processing apparatus 200) via the network 400 can be applied.

At least a part of each units (acquisition unit 101, detection unit 102, estimation unit 103, generation unit 104, and output control unit 105) may be implemented by one or more processors. Each of the above units is implemented by, for example, one or a plurality of processors. For example, each of the above units may be implemented by causing a processor such as a central processing unit (CPU) and a graphics processing unit (GPU) to execute a program, that is, by software. Each of the above units may be implemented by a processor such as a dedicated integrated circuit (IC), that is, hardware. Each of the above units may be implemented by using software and hardware in combination. When a plurality of processors is used, each processor may implement one of the units or two or more of the units.

The storage unit 121 stores various types of information used in the information processing apparatus 100. For example, the storage unit 121 stores the information (video or the like) acquired by the acquisition unit 101, the information of the machine learning model used by the detection unit 102, the processing result of each unit, and the like.

Note that the storage unit 121 can be configured by any commonly used storage medium such as a flash memory, a memory card, a random access memory (RAM), a hard disk drive (HDD), and an optical disc.

The information processing apparatus 100 may be physically configured by one apparatus or may be physically configured by a plurality of apparatuses. For example, the information processing apparatus 100 may be constructed on a cloud environment.

Furthermore, in FIG. 1, the imaging device 300, the information processing apparatus 100, and the information processing apparatus 200 are separately illustrated, but two or all of the respective apparatuses may be constructed in the same apparatus. For example, the information processing apparatus 100 and the information processing apparatus 200 may be constructed in one server apparatus, or may be constructed on a cloud environment.

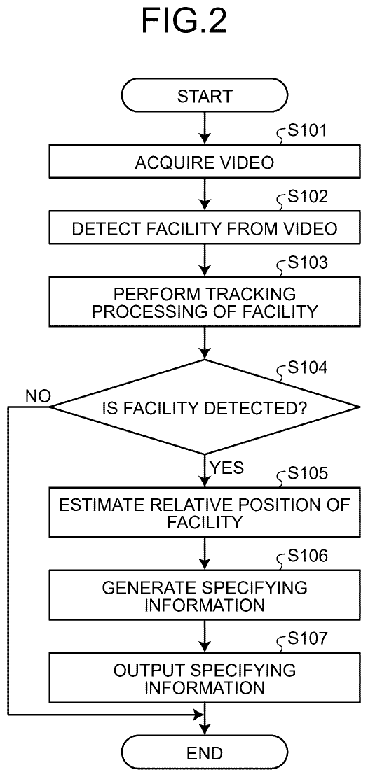

Next, generation processing by the information processing apparatus 100 will be described. FIG. 2 is a flowchart illustrating an example of generation processing according to the embodiment.

The acquisition unit 101 acquires the video captured by the imaging device 300 (Step S101). The detection unit 102 detects a facility from each image included in the video (Step S102). Furthermore, the detection unit 102 performs tracking processing on the facility detected from each image (Step S103). In the tracking process, facility ID of one or more facilities may be detected from the video.

The estimation unit 103 determines whether or not a facility has been detected (Step S104). When no facility is detected in Step S104 (Step S104: No), the generation processing ends.

When the facility is detected (Step S104: Yes), the estimation unit 103 estimates the relative position of the facility with respect to the imaging position of the image with respect to each image in which the facility is detected (Step S105).

The generation unit 104 generates the specifying information for each facility ID detected in Step S103 (Step S106). For example, the generation unit 104 generates the specifying information in which the facility ID of the detected facility, the facility information based on the relative position estimated in Step S105, and the image identification information (time, frame number, etc.) of the facility image are associated with each other.

The output control unit 105 outputs the generated specifying information for each facility ID (Step S107), and ends the generation processing.

In the images with different imaging positions, it is difficult to grasp a time-series change in the facility itself such as deformation and deterioration due to a difference in appearance of the facility. On the other hand, the information processing apparatus 100 according to the present embodiment generates and outputs specifying information in which the relative position of the facility and the detection result of the facility are associated with each other.

As will be described later, the specifying information can be used for image extraction and display by the information processing apparatus 200. For example, by using the specifying information, it is possible to extract facility images having close imaging positions (relative positions) from a plurality of videos captured at different dates and times. For example, by designating a facility image corresponding to a specific relative position, the user can compare a plurality of facility images having the same imaging position extracted from a plurality of videos captured at different dates and times. Since the plurality of facility images are expected to have the same appearance of facilities, the user can easily compare facilities captured at different times.

### First Modification

In the above embodiment, the example of estimating the relative position of the facility by SfM is described. The method for estimating the relative position is not limited to the method using SfM. In the first modification, an example will be described in which a disparity is estimated by stereo matching using stereo images captured by a plurality of imaging devices 300, and a relative position is estimated using the estimated disparity.

In the present modification, the information processing system 10 includes a plurality of imaging devices 300. The plurality of imaging devices 300 corresponds to stereo cameras that are two cameras arranged on the left and right in the horizontal direction. For example, the acquisition unit 101 acquires time-series stereo images captured by each of the plurality of imaging devices 300.

In the present modification, an image included in a video captured by one imaging device 300 (first imaging device) of the plurality of imaging devices 300 corresponds to an image IA, and an image included in a video captured by the other imaging device 300 (second imaging device) corresponds to an image IB. That is, the image IB is an image captured by the imaging device 300 different from the imaging device 300 that captures the image IA.

The detection unit 102 may detect an object using only an image (image IA) captured by one imaging device 300, or may detect an object using both images (image IA, image IB) captured by each of the plurality of imaging devices 300.

The estimation unit 103 estimates a disparity of a facility (object) by stereo matching using a stereo image, and estimates a relative position of the facility by using the disparity. In the present modification, the target image is both the image IA and the image IB. That is, the estimation unit 103 estimates the relative position using the disparity between the image IA and the image IB obtained from the stereo camera.

If the stereo image is calibrated in advance, the estimated relative position of the facility is based on absolute scale. Therefore, it is not necessary to correct the distance scale, and the processing time can be shortened as compared with the above embodiment. In addition, since the present modification uses the stereo image that is the image IA and the image IB captured at the same time, the processing time can be shortened as compared with the above embodiment using the image IA and the image IB captured at different times.

### Second Modification

In the second modification, the example of estimating the relative position of the facility by a depth image will be described. The depth image is an image including a depth representing a distance from an imaging position to a subject corresponding to each pixel as a pixel value of each pixel.

In the present modification, the information processing system 10 includes the imaging device 300 capable of capturing a depth image in addition to the imaging device 300 similar to that of the above embodiment. The imaging device 300 capable of capturing a depth image can be implemented by, for example, an infrared sensor or the like. Hereinafter, a case where a depth image is captured by an infrared sensor will be described as an example.

In the present modification, the acquisition unit 101 further acquires time-series depth images captured by the infrared sensor. In the present modification, the image included in the video captured by the imaging device 300 that is not the infrared sensor corresponds to the image IA, and the depth image captured by the infrared sensor corresponds to the image IB. That is, the image IB is a depth image including a depth for each pixel.

The detection unit 102 may detect an object from an image (image IA) included in a video captured by the imaging device 300 that is not an infrared sensor, or may detect an object by further using a depth image (image IB) captured by the infrared sensor.

In the present modification, the target image is a depth image (image IB). That is, the estimation unit 103 estimates the relative position of the facility using the target image that is the depth image. By using a perspective projection model or the like, the relative position of each pixel can be calculated from the pixel value of each pixel of the depth image (value indicative of the depth), the coordinates of each pixel, and the focal length. Therefore, the estimation unit 103 can estimate the relative position of the facility similarly to the above embodiment by using the relative position of each pixel calculated in this manner instead of the relative position of each pixel in SfM.

The depth acquired by the infrared sensor is based on a distance scale reflecting reality. Therefore, it is not necessary to correct the distance scale similarly to the first modification, and the processing time can be shortened as compared with the above embodiment.

### Third Modification

In the above embodiment, the specifying information is, for example, information in which facility ID, facility information, and image identification information of a facility image are associated with each other. The data structure of the specifying information is not limited thereto, and may further include other information.

For example, the specifying information may further include position information indicative of a position where the target image is captured. The position information may be, for example, lane information indicative of a lane on which the moving vehicle on which the imaging device 300 is mounted travels. The lane information can be obtained, for example, by analyzing the target image. The generation unit 104 of the present modification generates specifying information in which position information indicative of a position where a target image is captured is further associated.

In the method of extracting the corresponding image using only the facility information such as the relative position, the distance, and the angle, there is a possibility that images captured while the vehicle is traveling in different lanes are extracted as the corresponding image. By generating and outputting specifying information including position information such as lane information, it is possible to extract a corresponding image under a constraint that the position information matches or is similar. That is, it is possible to extract an image corresponding to higher accuracy.

Next, functions of the information processing apparatus 200 that extracts and displays an image using specifying information will be described. Using the specifying information output from the information processing apparatus 100, the information processing apparatus 200 extracts an image of the same facility and having a close value of the relative position of the facility from each of the plurality of videos captured by the imaging device 300, and displays the extracted plurality of images so as to be able to be compared with each other.

As illustrated in FIG. 1, the information processing apparatus 200 includes an acquisition unit 201, a determination unit 202, an extraction unit 203, a display control unit 204, and a display unit 221.

The display unit 221 is a display device that displays various types of information, and can be implemented by, for example, a liquid crystal display. The display unit 221 is not necessarily provided in the information processing apparatus 200, and may be provided in another device (terminal device or the like) connected via the network 400, for example.

The acquisition unit 201 acquires various types of information used in the information processing apparatus 200. For example, the acquisition unit 201 acquires a plurality of videos captured at different dates and times from the imaging device 300. Furthermore, the acquisition unit 201 acquires the specifying information output from the information processing apparatus 100 for each of the plurality of videos.

In a case where an anomaly is detected by comparing images, for example, a configuration is conceivable in which two images of an image in a video captured in the past and an image in the latest video are displayed so as to be able to be compared. Hereinafter, a case where two images extracted from two videos captured at different times are displayed will be described as an example. The number of videos (images) to be displayed is not limited to two, and may be three or more.

Hereinafter, an example in which two videos of a video MD1 captured at time t1 and a video MD2 captured at time t2 are used will be described. The video MD1 and the video MD2 may be videos captured at different dates and times by the same imaging device 300 (imaging device 300 mounted on the same moving vehicle), or may be videos captured by a plurality of different imaging devices 300 (imaging devices 300 mounted on a plurality of different moving vehicles). It is assumed that the video MD1 and the video MD2 include one or more facilities that are commonly imaged in both.

Hereinafter, the target images (at least one of the image IA and the image IB) captured at the time t1 and the time t2 are represented as a target image PI_t1 (first target image) and a target image PI_t2 (second target image), respectively. The specifying information generated using the target image PI_t1 and the target image PI_t2 is represented as specifying information SI_t1 (first specifying information) and specifying information SI_t2 (second specifying information), respectively.

The acquisition unit 201 acquires the specifying information SI_t1 and the specifying information SI_t2 from the information processing apparatus 100. In addition, the acquisition unit 201 acquires the video MD1 captured at the time t1 and the video MD2 captured at the time t2 from the imaging device 300.

The specifying information SI_t1 and the specifying information SI_t2 each include an independently allocated facility ID. Therefore, for example, even if the facility IDs included in the specifying information SI_t1 and the specifying information SI_t2 have the same value, the facility IDs do not necessarily indicate the same facility. Conversely, even if the facility IDs included in the specifying information SI_t1 and the specifying information SI_t2 have different values, the same facility may be indicated.

Therefore, the determination unit 202 determines whether or not the plurality of pieces of specifying information indicates the same facility, and performs association between the pieces of specifying information indicative of the same facility. For example, the determination unit 202 determines whether or not a facility (object) identified by facility ID (object identification information) included in the specifying information SI_t1 and a facility identified by facility ID included in the specifying information SI_t2 match each other. Then, the determination unit 202 assigns new facility ID (hereinafter, the common facility ID) to the facilities included in the specifying information SI_t1 and the specifying information SI_t2 such that the same value is obtained in a case where the same facility is indicated and a different value is obtained in a case where different facilities are indicated for the specifying information SI_t1 and the specifying information SI_t2.

Whether or not the facilities match, that is, whether or not the facilities are the same can be determined, for example, by the following method.

In a case where imaging positions obtained by GPS or the like are close (for example, in a case where a difference in imaging positions is equal to or less than a threshold value), it is determined that the facilities are the same.

When the similarity between the facility images corresponding to the same relative position is equal to or less than a threshold value, it is determined that the facilities are the same.

A plurality of facility images is displayed, and facilities designated as the same by the user with reference to the displayed facility images are determined as the same facility.

The extraction unit 203 extracts an image from each of the video MD1 and the video MD2 using one or more pieces of specifying information SI_t1 and one or more pieces of specifying information SI_t2 including the facility ID (common facility ID) of the facility determined to be matched.

For example, the extraction unit 203 extracts the target image identified by the image identification information included in the specifying information SI_t1 including the designated facility information (relative position, distance or angle) from the video MD1. Further, the extraction unit 203 extracts the target image identified by the image identification information included in the specifying information SI_t2 including the designated facility information from the video MD2.

As described above, designating the facility information corresponds to designating the imaging position (relative position). The method of designating the facility information may be any method, and for example, the following method can be applied.

A list of facility images corresponding to different facility information is displayed, and facility information corresponding to a facility image selected by a user or the like among the displayed facility images is used as designated facility information. The list of facility images may be either a list of facility images obtained from the video MD1 or a list of facility images obtained from the video MD2.

In the case of facility information represented by a scalar value such as a distance and an angle, the facility information is designated by using a user interface such as a slider for designating the scalar value.

In a case where the designation of the facility information is changed, the extraction unit 203 further extracts an image from each of the video MD1 and the video MD2 by using the changed facility information. For example, the extraction unit 203 extracts the target image identified by the image identification information included in the specifying information SI_t1 including the changed facility information from the video MD1. Further, the extraction unit 203 extracts the target image identified by the image identification information included in the specifying information SI_t2 including the changed facility information from the video MD2.

The display control unit 204 controls display of various types of information on the display unit 221. For example, the display control unit 204 displays a plurality of extracted images (target images) on the display unit 221 in association with each other so that the extracted images can be compared with each other.

At least a part of each units (acquisition unit 201, determination unit 202, extraction unit 203, and display control unit 204) may be implemented by one or more processors. Each of the above units is implemented by, for example, one or a plurality of processors. For example, each of the above units may be implemented by causing a processor such as a CPU and a GPU to execute a program, that is, by software. Each of the above units may be implemented by a processor such as a dedicated integrated circuit (IC), that is, hardware. Each of the above units may be implemented by using software and hardware in combination. When a plurality of processors is used, each processor may implement one of the units or two or more of the units.

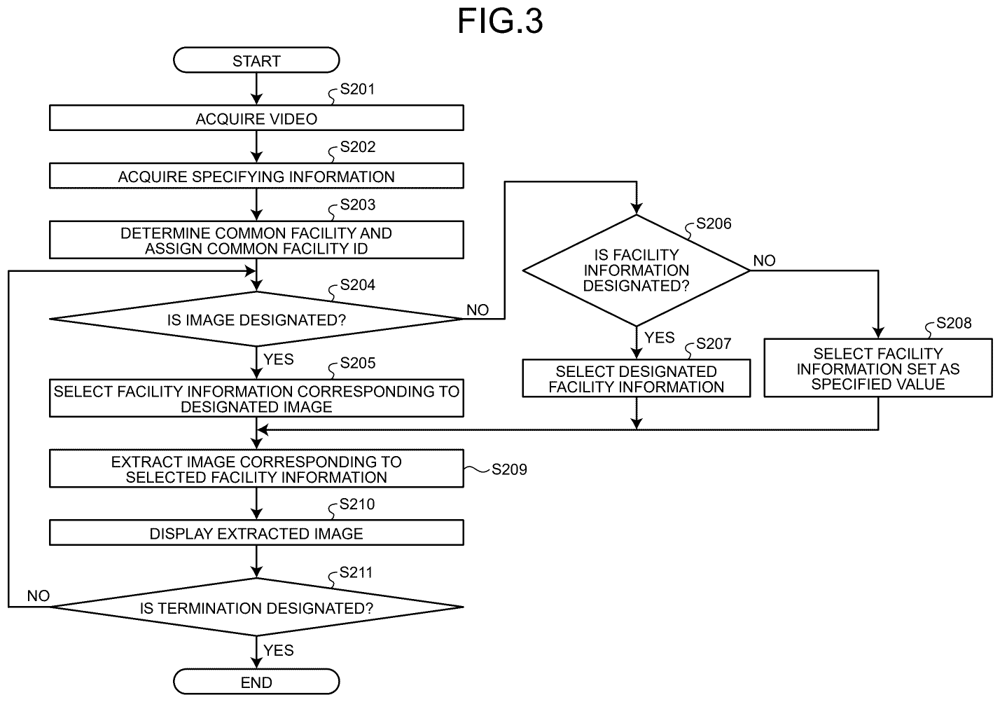

Next, display processing by the information processing apparatus 200 will be described. FIG. 3 is a flowchart illustrating an example of display processing according to the embodiment.

The acquisition unit 201 acquires the video MD1 and the video MD2 from the imaging device 300 (Step S201). The acquisition unit 201 acquires the specifying information SI_t1 and the specifying information SI_t2 output from the information processing apparatus 100 with each of the video MD1 and the video MD2 as an input (Step S202). Note that Step S201 and Step S202 need not be executed in the order illustrated in FIG. 3, and may be executed in the reverse order or may be executed in parallel.

The determination unit 202 determines whether or not a plurality of pieces of specifying information indicates the common facility (same facility), and assigns common facility ID to the common facility (Step S203).

The extraction unit 203 determines whether or not a facility image to be displayed is designated (Step S204). As described above, the facility image can be designated, for example, by being selected by the user from a list of a plurality of facility images.

When the facility image is designated (Step S204: Yes), the extraction unit 203 selects facility information corresponding to the designated facility image (Step S205). For example, the extraction unit 203 obtains the specifying information corresponding to the designated facility image, and selects the common facility ID assigned to the facility ID included in the obtained specifying information and the facility information (relative position, distance, or angle) included in the specifying information.

When the facility image is not designated (Step S204: No), the extraction unit 203 determines whether or not the facility information is designated (Step S206). For example, in a case where the facility information can be designated by a scalar value such as a distance or an angle, the extraction unit 203 determines whether or not a scalar value indicative of the facility information is designated.

When the facility information is designated (Step S206: Yes), the extraction unit 203 selects the designated facility information (Step S207). When the facility information is not designated (Step S206: No), the extraction unit 203 selects the facility information set as the specified value (Step S208). The specified value of the facility information is determined in advance as facility information that allows easy viewing of the facility according to the actual size of the facility and the angle of view of the imaging device 300, for example.

When a plurality of facilities are detected from the facility image, the extraction unit 203 may select designated common facility ID from among a plurality of common facility IDs allocated to the plurality of facilities. When the common facility ID is not designated, the extraction unit 203 selects one (for example, common facility ID having a small value) of the plurality of common facility IDs.

Next, the extraction unit 203 extracts a facility image corresponding to the common facility ID and the facility information selected (designated) in any one of Steps S205, S207, and S208 from the video MD1 using the specifying information SI_t1. Similarly, the extraction unit 203 extracts a facility image corresponding to the selected common facility ID and facility information from the video MD2 using the specifying information SI_t2 (Step S209).

The display control unit 204 displays the plurality of extracted facility images on the display unit 221 (Step S210).

The display control unit 204 determines whether or not the termination of display is designated (Step S211). When the termination of display is not designated (Step S211: No), the process returns to Step S204 and is repeated. When the termination of display is designated (Step S211: Yes), the display processing ends.

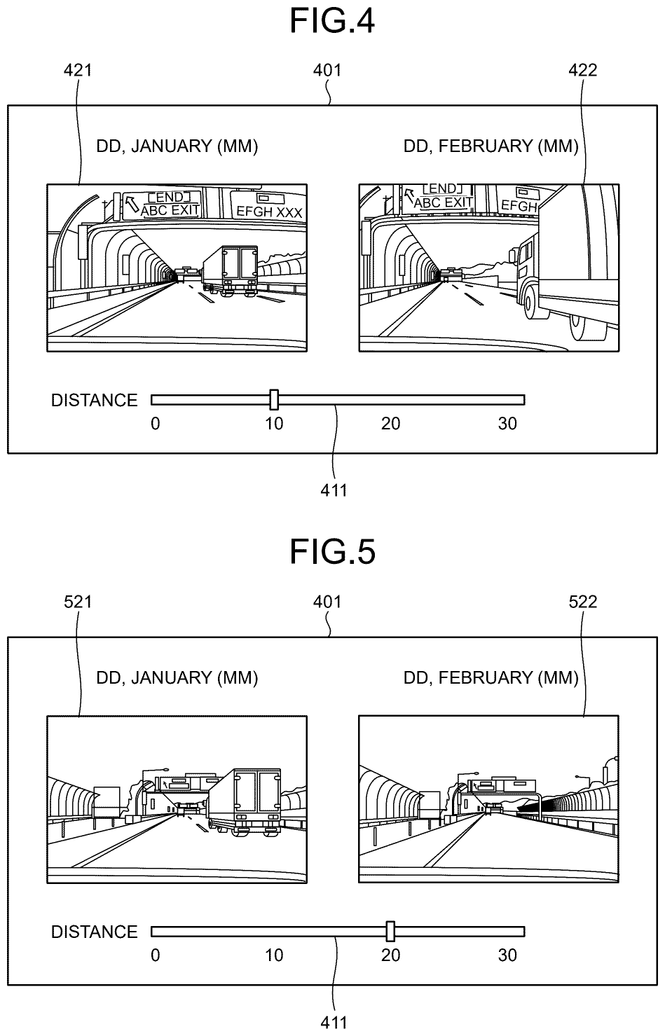

FIGS. 4 and 5 are views illustrating an example of the display screen displayed on the display unit 221. As illustrated in FIG. 4, a display screen 401 includes images 421 and 422 captured at different dates and times, and a slider 411 capable of designating a distance as facility information. FIG. 4 illustrates an example in which 10 is designated as the distance using the slider 411.

The image 421 corresponds to an image extracted by the specifying information SI_t1 including a distance having a value of 10 as the facility information among a plurality of images included in the video MD1 captured at the time t1 (DD, January (MM), which means a video-captured day in January). The image 422 corresponds to an image extracted by the specifying information SI_t2 including a distance having a value of 10 as the facility information among a plurality of images included in the video MD2 captured at the time t2 (DD, February (MM)).

FIG. 5 illustrates an example of the display screen 401 in a case where the designation of the distance is changed to 20 by the slider 411. The image 521 corresponds to an image extracted by the specifying information SI_t1 including a distance having a value of 20 as the facility information among a plurality of images included in the video MD1 captured at the time t1 (DD, January (MM)). The image 522 corresponds to an image extracted by the specifying information SI_t2 including a distance having a value of 20 as the facility information among a plurality of images included in the video MD2 captured at the time t2 (DD, February (MM)).

In this manner, the information processing apparatus 200 extracts a plurality of images corresponding to the designated facility information (relative position, distance, or angle) from among images obtained by imaging the same facility included in a plurality of videos, and displays the extracted plurality of images in a comparable manner. As a result, it is possible to easily grasp the time-series change of the facility itself except for the influence of the difference in the appearance of the facility due to the difference in the imaging position.

### Fourth Modification

In the above embodiment, an example has been described in which one facility image corresponding to the selected one facility information is extracted from each video (video MD1, video MD2), and a set of facility images extracted from each video is displayed. Two or more sets of images may be extracted and displayed.

For example, the user designates two or more types of facility information (relative position, distance, or angle). The extraction unit 203 extracts two or more sets of images by using each of the designated two or more types of facility information. The display control unit 204 displays two or more sets of images on the display unit 221 in association with each other so that the two or more sets of images can be compared with each other.

As a result, for example, it is possible to more easily grasp the difference in appearance of the facility according to the imaging position. For example, only when viewed from a specific distance, it is possible to easily grasp a situation where the facility is hidden by trees, signboards, or the like.

### Fifth Modification

In the above embodiment, it is possible to display facility images of all facilities in accordance with designation by a user or the like. On the other hand, it may be required to display only an image of a specific type of a facility or a facility captured at a specific imaging position. In the fifth modification, only a facility designated to be displayed is to be displayed.

For example, the extraction unit 203 extracts, from the video MD1, the target image identified by the image identification information included in the specifying information SI_t1 including the facility ID of the facility of the designated type and the designated facility information. Further, the extraction unit 203 extracts, from the video MD2, the target image identified by the image identification information included in the specifying information SI_t2 including the facility ID of the facility of the designated type and the designated facility information.

The imaging position may be designated by a range of the imaging position. In this case, the extraction unit 203 extracts, from the video MD1, the target image captured at the imaging position within the designated range and identified by the image identification information included in the specifying information SI_t1 including the designated facility information. Further, the extraction unit 203 extracts, from the video MD2, the target image captured at the imaging position within the designated range and identified by the image identification information included in the specifying information SI_t2 including the designated facility information.

As a result, the user can display and compare images corresponding to the relative position of the facility only for the facility of a desired type or the facility imaged at a desired imaging position.

As described above, in the embodiment, it is possible to more easily compare a plurality of images obtained by capturing an object such as a road facility.

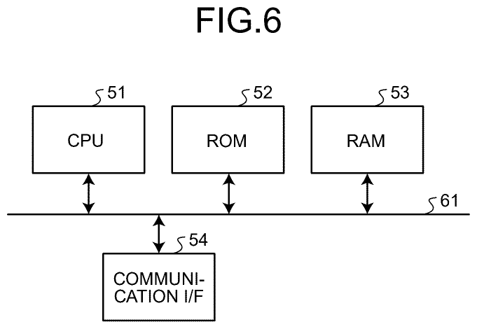

Next, a hardware configuration of the information processing apparatus according to the embodiment will be described with reference to FIG. 6. FIG. 6 is an explanatory diagram illustrating a hardware configuration example of the information processing apparatus according to the embodiment.

The information processing apparatus according to the embodiment includes a control device such as a central processing unit (CPU) 51, a storage device such as a read only memory (ROM) 52 and a random access memory (RAM) 53, a communication I/F 54 that is connected to a network and performs communication, and a bus 61 that connects the respective units.

The program executed by the information processing apparatus according to the embodiment is provided by being incorporated in the ROM 52 or the like in advance.

The program executed by the information processing apparatus according to the embodiment may be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Furthermore, the program executed by the information processing apparatus according to the embodiment may be stored on a computer connected to a network such as the Internet and provided by being downloaded via the network. Furthermore, the program executed by the information processing apparatus according to the embodiment may be provided or distributed via a network such as the Internet.

The program executed by the information processing apparatus according to the embodiment can cause a computer to function as each unit of the information processing apparatus described above. In this computer, the CPU 51 can read a program from a computer-readable storage medium onto a main storage device and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
one or more hardware processors configured to:
acquire a first image and a second image;
detect an object captured in the first image by using at least the first image;
estimate a relative position of the object based on an imaging position of a target image by using the target image that is at least one of the first image and the second image; and
generate specifying information in which object identification information for identifying the object, facility information based on the relative position, and image identification information for identifying the target image are associated with each other.

2. The information processing apparatus according to claim 1, wherein
the second image is an image captured, by an imaging device that captures the first image, at an imaging position different from an imaging position of the first image, and
the one or more hardware processors are configured to estimate the relative position from a correspondence relationship of points between the first image and the second image included in one or more image pairs that are a set of the first image and the second image.

3. The information processing apparatus according to claim 2, wherein
the one or more hardware processors are configured to estimate the relative position by further using at least a part of the imaging position, a height of the imaging device, a speed at which the imaging device moves, and a size of a subject captured in the target image.

4. The information processing apparatus according to claim 1, wherein
the second image is an image captured by a second imaging device different from a first imaging device that captures the first image, and
the one or more hardware processors are configured to estimate the relative position using a disparity between the first image and the second image.

5. The information processing apparatus according to claim 1, wherein
the second image is a depth image including a depth for each pixel, and
the one or more hardware processors are configured to estimate the relative position using the target image that is the depth image.

6. The information processing apparatus according to claim 1, wherein
the one or more hardware processors are configured to generate the specifying information, for which position information indicative of a position where the target image is captured, is further associated.

7. The information processing apparatus according to claim 1, wherein the one or more hardware processors are configured to:
determine whether or not the object identified by the object identification information included in first specifying information generated using the target image captured at time t1 matches the object identified by the object identification information included in second specifying information generated using the target image captured at time t2;
extract the target image identified by the image identification information included in the first specifying information including the designated facility information and the target image identified by the image identification information included in the second specifying information including the designated facility information by using one or more pieces of the first specifying information and one or more pieces of the second specifying information including the object identification information of the object determined to be matched; and
display a plurality of extracted target images on a display device in association with each other.

8. An information processing apparatus comprising:
one or more hardware processors configured to:
acquire first specifying information generated by using a first target image captured at a time t1 and second specifying information generated by using a second target image captured at a time t2, the first specifying information and the second specifying information being specifying information in which object identification information for identifying an object detected by using at least first image out of the first image and a second image, a relative position of the object with respect to an imaging position of a target image estimated by using the target image that is at least one of the first image and the second image, and image identification information for identifying the target image are associated with each other;
determine whether or not the object identified by the object identification information included in the first specifying information matches the object identified by the object identification information included in the second specifying information;
extract the target image identified by the image identification information included in the first specifying information including the designated facility information among the facility information based on the relative position and the target image identified by the image identification information included in the second specifying information including the designated facility information by using one or more pieces of the first specifying information and one or more pieces of the second specifying information including the object identification information of the object determined to be matched; and
display a plurality of extracted target images on a display device in association with each other.

9. The information processing apparatus according to claim 8, wherein
when designation of the facility information is changed, the one or more hardware processors are configured to extract the target image identified by the image identification information included in the first specifying information including the changed facility information and the target image identified by the image identification information included in the second specifying information including the changed facility information.

10. The information processing apparatus according to claim 8, wherein
the one or more hardware processors are configured to extract the target image identified by the image identification information included in the first specifying information including the object identification information of the object of a designated type and the designated facility information, and the target image identified by the image identification information included in the second specifying information including the object identification information of the object of the designated type and the designated facility information.

11. The information processing apparatus according to claim 8, wherein
the one or more hardware processors are configured to extract the target image captured at an imaging position within a designated range and identified by the image identification information included in the first specifying information including the designated facility information, and the target image captured at an imaging position within the range and identified by the image identification information included in the second specifying information including the designated facility information.

12. An information processing method executed by a computer of an information processing apparatus, the method comprising:
acquiring a first image and a second image;
detecting an object captured in the first image by using at least the first image;
estimating a relative position of the object based on an imaging position of a target image by using the target image that is at least one of the first image and the second image; and
generating specifying information in which object identification information for identifying the object, facility information based on the relative position, and image identification information for identifying the target image are associated with each other.

13. An information processing method executed by a computer of an information processing apparatus, the method comprising:
acquiring first specifying information generated by using a first target image captured at a time t1 and second specifying information generated by using a second target image captured at a time t2, the first specifying information and the second specifying information being specifying information in which object identification information for identifying an object detected by using at least first image out of the first image and a second image, a relative position of the object with respect to an imaging position of a target image estimated by using the target image that is at least one of the first image and the second image, and image identification information for identifying the target image are associated with each other;
determining whether or not the object identified by the object identification information included in the first specifying information matches the object identified by the object identification information included in the second specifying information;
extracting the target image identified by the image identification information included in the first specifying information including the designated facility information among the facility information based on the relative position and the target image identified by the image identification information included in the second specifying information including the designated facility information by using one or more pieces of the first specifying information and one or more pieces of the second specifying information including the object identification information of the object determined to be matched; and
displaying a plurality of extracted target images on a display device in association with each other.

14. A computer program product having a non-transitory computer readable medium including programmed instructions stored thereon, wherein the instructions, when executed by a computer, cause the computer to execute:
acquiring a first image and a second image;
detecting an object captured in the first image by using at least the first image;
estimating a relative position of the object based on an imaging position of a target image by using the target image that is at least one of the first image and the second image; and
generating specifying information in which object identification information for identifying the object, facility information based on the relative position, and image identification information for identifying the target image are associated with each other.

15. A computer program product having a non-transitory computer readable medium including programmed instructions stored thereon, wherein the instructions, when executed by a computer, cause the computer to execute:
acquiring first specifying information generated by using a first target image captured at a time t1 and second specifying information generated by using a second target image captured at a time t2, the first specifying information and the second specifying information being specifying information in which object identification information for identifying an object detected by using at least first image out of the first image and a second image, a relative position of the object with respect to an imaging position of a target image estimated by using the target image that is at least one of the first image and the second image, and image identification information for identifying the target image are associated with each other;
determining whether or not the object identified by the object identification information included in the first specifying information matches the object identified by the object identification information included in the second specifying information;
extracting the target image identified by the image identification information included in the first specifying information including the designated facility information among the facility information based on the relative position and the target image identified by the image identification information included in the second specifying information including the designated facility information by using one or more pieces of the first specifying information and one or more pieces of the second specifying information including the object identification information of the object determined to be matched; and
displaying a plurality of extracted target images on a display device in association with each other.
